(19) United States
(12) Patent Application Publication
(10) Pub. No.: US 2025/0342008 A1
(43) Pub. Date: Nov. 6, 2025

(54) API AND POLICY COMPLIANCE GOVERNANCE AS A SERVICE

(71) Applicant: Dell Products L.P., Round Rock, TX (US)

(72) Inventors: Ching-Yun Chao, Austin, TX (US); Ruchika Goyal, Cary, NC (US); Patrick J. O'Rourke, Lunenburg, MA (US); Fnu Manoj Kumar, Holly Springs, NC (US); David Woods, Snoqualmie, WA (US); Gauri Wagle, Austin, TX (US)

(21) Appl. No.: 18/655,487

(22) Filed: May 6, 2024

(51) Int. Cl. G06F 8/10

(52) U.S. Cl. CPC G06F 8/10

(57) ABSTRACT

Architectures and techniques are described that can implement or rely upon multiple different sources of truth (SOT) repositories, each of which can comprise authoritative versions of codebase, configurations, or other artifacts for different environments of an orchestration platform. For example, a first SOT repository can be utilized for a staging environment of the orchestration platform, while a second SOT repository, which differs from the first SOT repository, can be utilized for a production environment of the orchestration platform. Moreover, the disclosed techniques can tie a formal review process to a deployment process for a software development project, e.g., by enforcing certain deployment constraints.

### BACKGROUND

In a general sense, provision of something “as a service” indicates terms of art used in the technology industry to describe a service delivery model where a provider delivers a particular service over the internet on a subscription basis. Such focuses on a model in which the service is provided remotely via the internet, eliminating the need for customers to install or maintain on-premises hardware or software. Instead, users access the service through web-based interfaces or application programming interfaces (APIs). API and policy compliance governance relates to a significant aspect for software development platforms.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 depicts a schematic block diagram illustrating certain functionality or operation of an orchestration platform in accordance with certain embodiments of this disclosure;

FIG. 2 depicts a schematic block diagram illustrating certain portions of the CI/CD pipeline in the context of API and policy governance and in accordance with certain embodiments of this disclosure;

FIG. 3 depicts an example schematic block diagram illustrating an implementation that utilizes multiple sources of truth in accordance with certain embodiments of this disclosure;

FIG. 4 depicts a schematic block diagram illustrating an example device that can rely on multiple authoritative sources of truth as a function of an operative environment of an orchestration platform in accordance with certain embodiments of this disclosure;

FIG. 5 depicts a schematic block diagram illustrating additional aspects or elements of the example device that can rely on multiple authoritative sources of truth as a function of an operative environment of an orchestration platform in accordance with certain embodiments of this disclosure;

FIG. 6A depicts a schematic block diagram illustrating certain process flow aspects of API and policy governance with respect to a development environment of the orchestration platform in accordance with certain embodiments of this disclosure;

FIG. 6B depicts a schematic block diagram illustrating certain process flow aspects of API and policy governance with respect to a staging environment of the orchestration platform in accordance with certain embodiments of this disclosure;

FIG. 7 depicts a schematic block diagram illustrating certain process flow aspects of API and policy governance with respect to a production environment of orchestration platform 106 in accordance with certain embodiments of this disclosure;

FIG. 8 depicts a schematic block diagram illustrating various deployment constraints being enforced in connection with a production environment of the orchestration platform in accordance with certain embodiments of this disclosure;

FIG. 9 illustrates an example method that can select from among multiple authoritative sources of truth based on an operative environment of an orchestration platform in accordance with certain embodiments of this disclosure;

FIG. 10 illustrates an example method that can provide for additional functionality or elements relating to selecting from among multiple authoritative sources of truth based on an operative environment of an orchestration platform in accordance with certain embodiments of this disclosure;

FIG. 11 illustrates a block diagram of an example distributed file storage system that employs tiered cloud storage in accordance with certain embodiments of this disclosure; and

FIG. 12 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

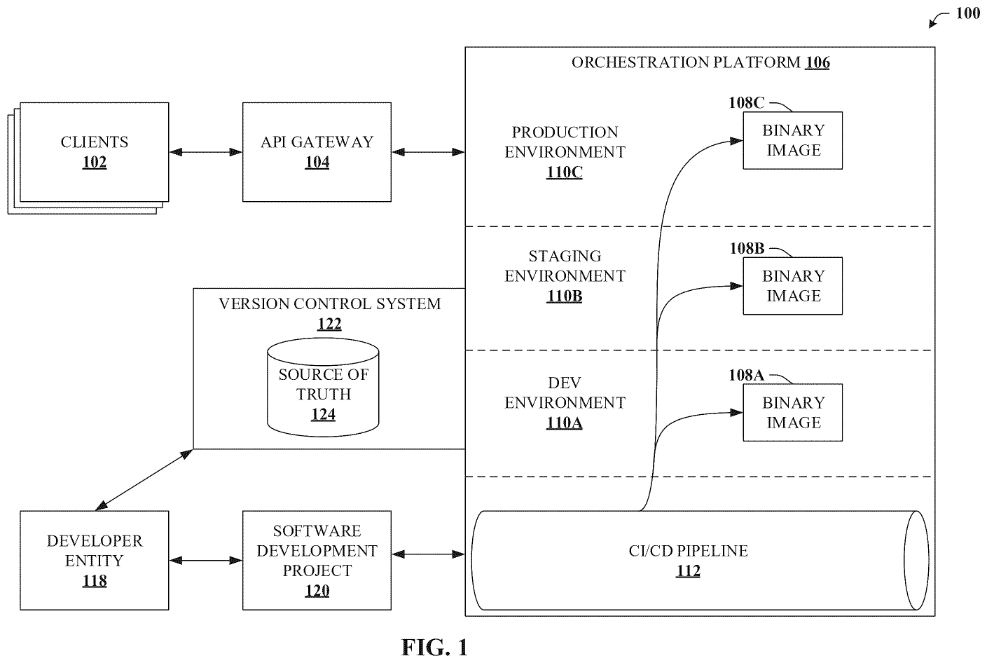

To provide additional context for the disclosed subject matter, consider an example architecture associated with an orchestration platform, illustrated in connection with FIG. 1. FIG. 1 depicts a schematic block diagram 100 illustrating certain functionality or operation of an orchestration platform 106 in accordance with certain embodiments of this disclosure. As used herein, orchestration platform 106 can be any suitable software development and/or software deployment platform such as a microservices platform. In some embodiments, orchestration platform 106 can be a containerized orchestration platform such as Kubernetes, Docker Swarm, or the like. In general, orchestration platform 106 can facilitate the management, provisioning, and configuration of multiple environments 110 in order to support software development, testing, and deployment workflows.

For example, orchestration platform 106 can comprise various different environments 110, including, as non-limiting representative examples, a development (dev) environment 110A, staging environment 110B, and production environment 110C. Dev environment 110A can relate to an environment used by a developer (e.g., developer entity 118) to write, test, and debug a given software development project 120 before being deployed to higher-level environments 110. In some embodiments, dev environment 110A can mirror production environment 110C in terms of software stack and configuration but may have fewer resources or simplified infrastructure. Developer entity 118 can use dev environment 110A to experiment with new features, fix bugs, and iterate on code changes rapidly without impacting other environments 110. In some embodiments, dev environment 110A can contain mock services, stubs, or test data to simulate external dependencies and enable isolated testing.

Staging environment 110B, sometimes referred to as a pre-production or quality assurance environment, can more closely resembles production environment 110C and can serve as a final testing ground before code changes are promoted to production environment 110C. Staging environment 110B can replicate infrastructure, configurations, and data of production environment 110C as closely as possible to validate that changes behave as expected in a production-like environment. Quality assurance teams, testers, and stakeholders can use the staging environment 110B to conduct integration tests, regression tests, performance tests, and user acceptance tests (UAT) to ensure that the application meets quality standards and business requirements. Staging environment 110B is typically isolated from external users and traffic, allowing teams to perform thorough testing without impacting live production systems. However, in some embodiments, staging environment 110B (and potentially dev environment 110A) can have a separate API gateway 104, potentially ones that are not accessible to public API traffic, which is further detailed below. Once changes are validated and approved in staging environment 110B, software development project 120 can be deemed ready for deployment to production environment 110C.

Production environment 110C represents the live, operational environment where the application or service associated with software development project 120 is accessed and used by end-users or customers, shown here as clients 102. Production environment 110C can host the released version of the software and can be responsible for handling real-world traffic, data, and transactions. The production environment 110C can be optimized for performance, reliability, scalability, and security to ensure uninterrupted service and positive user experience. Changes to the production environment 110C can be carefully managed and controlled through formal release processes, change management procedures, and deployment automation to minimize downtime, errors, and disruptions.

To these and other ends, orchestration platform 106 can comprise or be communicatively coupled to version control system (VCS) 122. For example, any environment 110 can integrate with VCS 122 in order to potentially automate a build, test, or deployment process. Furthermore, in some embodiments, orchestration platform 106 can be integrated with continuous integration/continuous deployment (CI/CD) pipeline 112.

In more detail, VCS 122 can relate to a system or device that can help developer entity 118 manage changes to source code and other files over time such as software development project 120. VCS 122 can provide a centralized repository where developer entity 118 can store, track, and collaborate on code changes, enabling teams to work together efficiently and maintain a history of revisions. VCS 122 can facilitate history tracking (e.g., VCS 122 can record all changes made to files in the repository), branching and merging (e.g., VCS 122 can support branching to create separate lines of development without affecting the main codebase), collaboration (e.g., VCS 122 can enable multiple developers to work on the same codebase concurrently), backup and recovery (e.g., VCS 122 can serve as a centralized backup mechanism for code and project asses of software development project 120), auditing and compliance (e.g., VCS 122 can proved a complete audit trail of code changes, allowing monitoring of access, permissions, contributions, and so on), and experimentation and versioning (e.g., VCS 122 can enable developer entity 118 to experiment with new ideas, features, or configurations via branching or tags for different versions of code).

VCS 122 can further comprise source of truth 124. In conventional literature or systems, a source of truth refers to a single, authoritative source for storing and managing the codebase, configuration files, and other artifacts related to software development and deployment processes such as software development project 120. The source of truth 124 can serve as the central repository from which all changes and updates are made, ensuring consistency, reliability, and traceability throughout the CI/CD workflow.

As depicted here, the source of truth (e.g., source of truth 124) typically resides in a version control system (e.g., VCS 122) such as Git, Subversion, or Mercurial. However, it is understood that the source of truth may reside elsewhere without departing from the scope or spirit of the disclosed techniques. Regardless, when developer entity 118 commits code changes to a repository (e.g., source of truth 124) of VCS 122, all such changes can be versioned, tracked, and managed over time. In that regard, VCS 122 along with source of truth 124 can act as the definitive record of the codebase, allowing developers to collaborate, review changes, and maintain a complete history of revisions.

In addition to code, source of truth 124 may also include configuration files, documentation, infrastructure-as-code (IaC) templates, and other artifacts that are utilized for building, testing, and deploying software applications. By centralizing various components of the development process in a single source of truth 124, CI/CD pipeline 112 can automate workflows, enforce consistency, and facilitate collaboration among development teams.

CI/CD pipeline 112 can represent any suitable development operations (DevOps) pipeline. CI/CD pipeline 112 can integrate seamlessly with orchestration platform 106 to automate the deployment and management of applications or other software components such as microservices.

For example, when integrated with a containerized orchestration platform, developer entity 118 can package software development project 120 and dependencies into container images using containerization tools like Docker. These container images encapsulate the application code, runtime environment, libraries, and dependencies, ensuring consistency and portability across different environments.

Whenever developer entity 118 pushes code changes to the VCS 122 repository, a continuous integration (CI) server can trigger a build process to create a new container image. The CI server retrieves the source code, builds the application, runs automated tests, and packages the application into a container image. Once the container image is built and tested successfully, the CI/CD pipeline 112 can orchestrate the deployment of the containerized application to the container orchestration platform (e.g., orchestration platform 106). The continuous deployment (CD) pipeline can automate the deployment process, ensuring that the latest version of the software deployment project 120 is deployed consistently across all environments 110.

Hence, as a representative example, software development project 120 can be directed to a microservice. When source code is committed, binary images 108 can be built by CI/CD pipeline 112. Each environment 110 can comprise a different binary image 108 (e.g., 108A, 108B, 108C), generally corresponding to the developmental progression stages that are performed in the associated environment 110.

Thus, orchestration platform 106 can have deployed thereon binary image 108C that can be indicative of a released version of some software development project 120. In the process of developing the released version (e.g., binary image 108C) other environments (e.g., staging environment 110B and dev environment 110A) can have their own earlier versions or as yet unreleased newer versions, illustrated as binary images 108B, 108A.

One example of binary image 108 can be a microservice. Microservices can communicate with one another via well-defined application programming interfaces (APIs), such as representational state transfer (REST) APIs, also referred to as RESTful APIs. Each microservice can represent a loosely coupled, independently deployable, self-contained service that serves a specific function or capability. Microservices can differ from traditional monolithic applications due to this architectural design. For example, an application can make API calls to one or more microservices instead of coding the function or capability into the application in a monolithic way. Hence, a given microservice can provide a dedicated function or capability to many different applications or other microservices in a more resilient and scalable manner.

For example, clients 102 that execute applications can make calls to microservices (or another software component represented by binary image 108) of orchestration platform 106. In some embodiments, any such communication can be via API gateway 104. API gateway 104 can be a server that acts as a single entry point for clients 102 to access multiple microservices 108. API gateway 104 can serve as a reverse proxy that routes requests from clients 102 to the appropriate microservices 108, abstracting away potential complexities of the underlying microservices architecture.

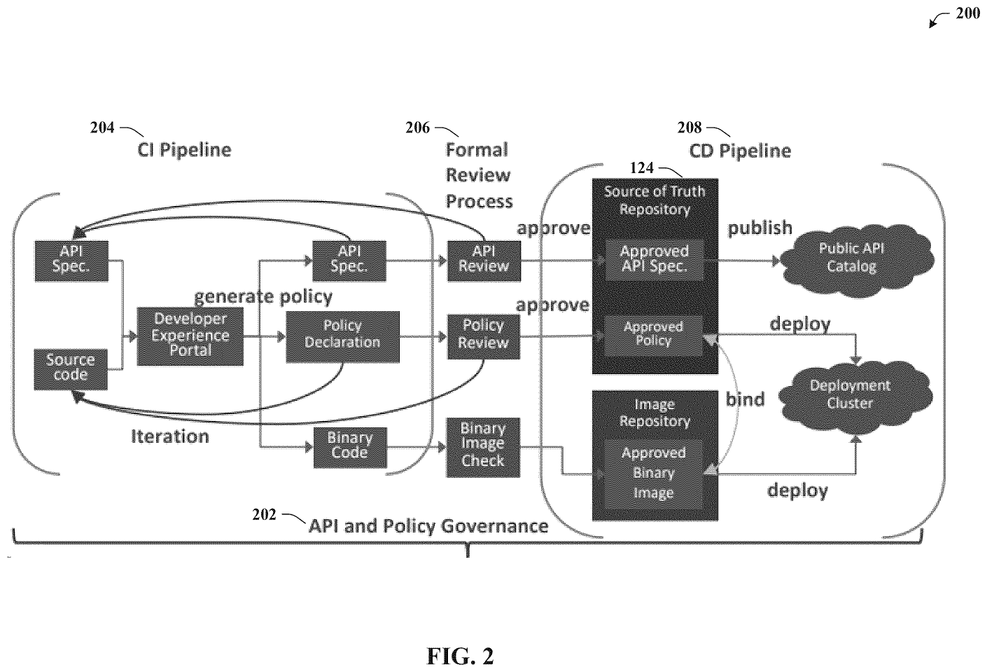

As indicated in the background section, API and policy compliance governance relates to a significant aspect for software development platforms and various aspects in that regard are described in connection with FIG. 2. Referring now to FIG. 2, a schematic block diagram 200 is depicted illustrating certain portions of CI/CD pipeline 112 in the context of API and policy governance 202 and in accordance with certain embodiments of this disclosure.

For example, for any development platform such as orchestration platform 106 in which microservices are accessed or anything is offered as a service, the platform is responsible for ensuring APIs, access control policy, network policy, and so forth satisfy quality and compliance targets. The quality and compliance targets generally seek to minimize security exposure, attack risks, to meet delivery and scalability goals, and so on. Hence, API and policy governance 202 represents a significant aspect of any such development platform (e.g., orchestration platform 106).

The results of some software development project 120, after sufficient development and testing can be deployed to production environment 110C, e.g., via CD pipeline 208. However, before that stage, certain best practices may indicate that various files such as an API specification file, an API policy specification file (also referred to as simply a policy file), source code, binary code, and so on may be formally reviewed by certain experts and/or a governance body, e.g., via formal review process 206. Such can involve multiple iterations within CI pipeline 204 before approval.

Yet, to implement such API and policy governance 202 the manner in which CD pipeline 208 allows formally reviewed APIs and policies to be deployed to production environment 110C of orchestration platform 106 should be considered. It may also be considered the manner in which CD pipeline 208 supports or furthers rapid or agile development by allowing new APIs and policy. Such can involve the question of whether those new files are from fixes, new features, or from new offers to deploy staging environment 110B while still maintaining the stability of staging environment 110B. Furthermore, it may be considered how CD pipeline 208 can support developer entity 118 in creating APIs and policies for rapid deployment to dev environment 110A of orchestration platform 106.

The disclosed subject matter, in some embodiments, is directed to resolving the above-mentioned considerations and/or issues in a manner that enhances the aims API and policy governance 202 while increasing the agility of developer entity 118 with respect to any given software development project 120 that is developed and/or deployed to orchestration platform 106.

### Example Systems

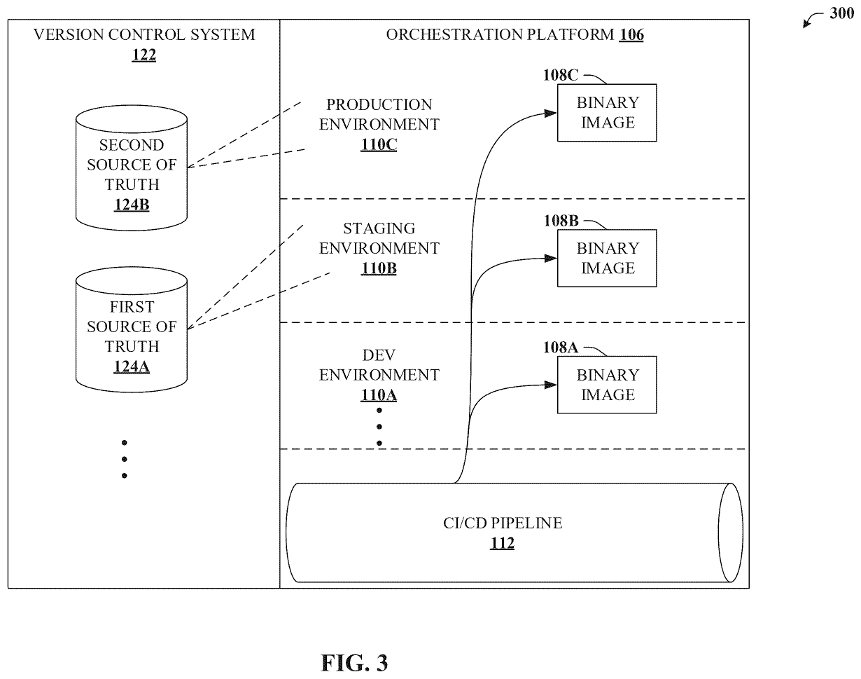

Turning now to FIG. 3, an example schematic block diagram 300 is depicted illustrating an implementation that utilizes multiple sources of truth 124 in accordance with certain embodiments of this disclosure. As introduced above, conventionally, source of truth 124 represents a single, authoritative source for the codebase, configuration files, and other artifacts related to any given software development project 120.

However, in accordance with the disclosed techniques source of truth 124 is not a single source, but in fact represents multiple sources of truth 124. Namely, VCS 122 can comprise first source of truth 124A and second source of truth 124B, and the two different sources of truth 124 can differ. To resolve potential conflicts, it is an aspect of some embodiments of the disclosed subject matter that different sources of truth 124 can be exclusively associated with respective different environments 110 of orchestration platform 106

For example, as illustrated, first source of truth 124A can be associated with staging environment 110B. Although not expressly indicated, in some embodiments, first source of truth 124A might be associated with lower stage environments 110 such as dev environment 110A or another. Second source of truth 124B on the other hand can be exclusively associated with production environment 110C.

Hence, from a high-level perspective, while multiple (potentially different) authoritative sources of truth 124 can exist, within a given environment 110 of orchestration platform 106, there can still be a single (e.g., only one) authority. As will be further examined below, implementing multiple sources of truth 124 can facilitate numerous advantages such as facilitating a progressive governance model connecting API development, policy declaration, and API, policy, and binary image binding to satisfy compliance efforts (e.g., API and policy governance 202) throughout the entirety of the CI/CD pipeline 112 and/or development of software development project 120.

Another advantage of implementing multiple different sources of truth 123 is that respective sources can have different owners. For example, first source of truth 124A can be owned and/or managed by developer entity 118, whereas second source of truth 124B can be owned and/or managed by a governance body of orchestration platform 106. From a security perspective, such can maximize the flexibility and agility for developer entity 118 to manage software development project 120 according to any suitable dev allocation without hard compliance constraints prior to deployment to production environment 110C.

Still another advantage can be that the above can facilitate tying a formal review process (e.g., formal review process 206) to the deployment process, which can, in some embodiments, facilitate the automation of providing API and policy governance as a service.

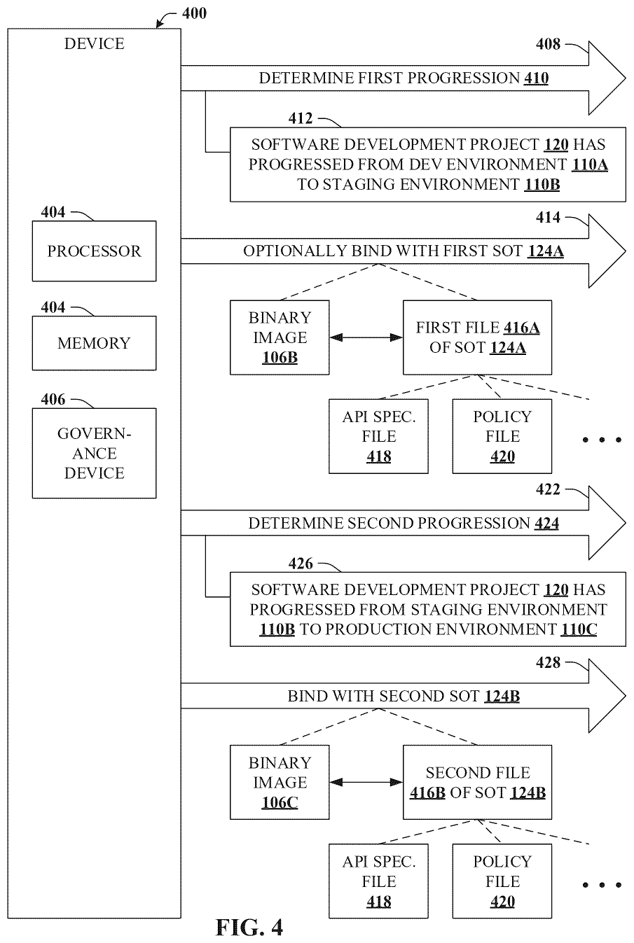

With reference now to FIG. 4, a schematic block diagram is depicted illustrating an example device 400 that can rely on multiple authoritative sources of truth 124 as a function of an operative environment 110 of an orchestration platform 106 in accordance with certain embodiments of this disclosure. In some embodiments, device 400 can be integrated with, a portion of, or communicatively coupled to a microservices platform or an orchestration platform such as orchestration platform 106.

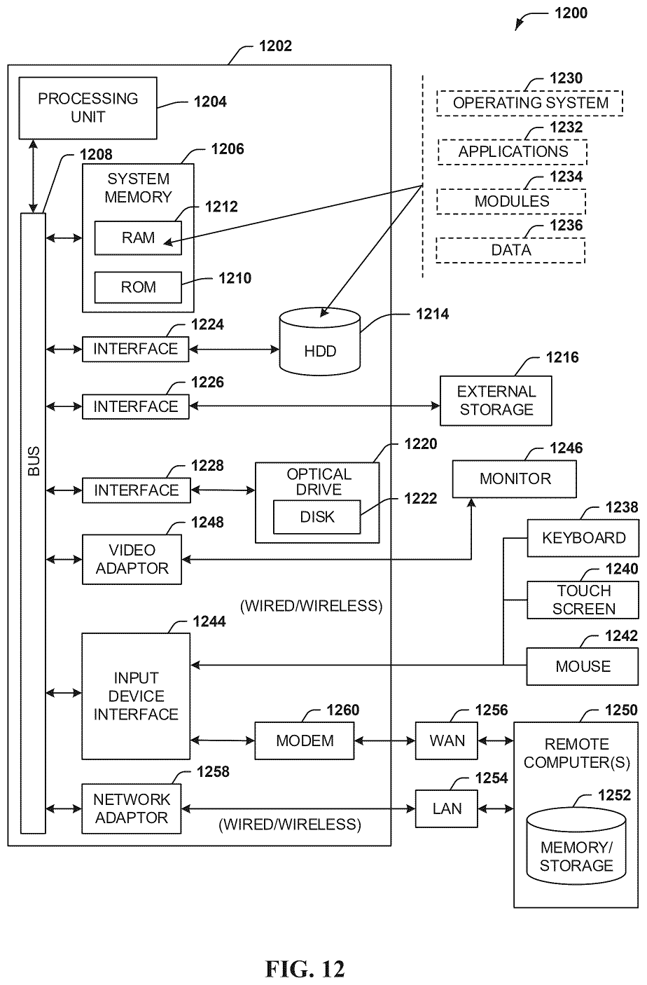

Device 400 can comprise a processor 402 that, potentially along with governance device 406, can be specifically configured to perform functions associated with API and policy governance 202. Device 400 can also comprise memory 404 that stores executable instructions that, when executed by processor 402, can facilitate performance of operations. Processor 402 can be a hardware processor having structural elements known to exist in connection with processing units or circuits, with various operations of processor 402 being represented by functional elements shown in the drawings herein that can require special-purpose instructions, for example, stored in memory 404 and/or governance device 406. Along with these special-purpose instructions, processor 402 and/or governance device 406 can be a special-purpose device. Further examples of the memory 404 and processor 402 can be found with reference to FIG. 12. It is to be appreciated that device 400 or computer 1202 can represent a server device or a client device of a network or data services platform and certain elements of computer 1202 can be used in connection with implementing one or more of the systems, devices, or components shown and described in connection with FIG. 4 and other figures disclosed herein.

As illustrated at reference numeral 408, device 400 can determine a first progression 410 has occurred. As exemplified at reference numeral 412, first progression 410 can relate to a determination that some software development project 120 has progressed from a first environment 110 (e.g., dev environment 110A) of orchestration platform 106 to a second different environment 110 (e.g., staging environment 110B) of orchestration platform 106.

In response to first progression 410, device 400 can perform a binding procedure 414 in connection with first source of truth 124A. In that regard, a binary image (e.g., binary image 106B) that exists in staging environment 110B can be bound to one or more first files 416A of the first source of truth 124A. In some embodiments, binding procedure 414 can relate to marking or tagging a data structure or metadata structure of binary image 106 or with a reference to first file(s) 416A. As one result of binding procedure 414, it can be ensured that a given binary image 106 can be immutably bound to first file(s) 416A of a source of truth repository (e.g., first source of truth 124A).

The one or more first files 416A can comprise API specification file 418, policy file 420, or another suitable file or data structure. In more detail, API specification file 418 can define a structure, an endpoint, a parameter, or a response associated with an API of software development project 120. Policy file 420 can relate to an API policy specification comprising a configuration setting or rule that defines how the API of software development project 120 is accessed, secured, or managed. Hence, policy file 420 can describe API visibility (e.g., public, internal, external, private, . . . ) and/or API accessibility (e.g., roles, permissions, conditions, . . . ).

At reference numeral 422, device 400 can determine second progression 424. As indicated at reference numeral 426, second progression 424 can relate to a determination that some software development project 120 has progressed from the second environment 110 (e.g., staging environment 110B) of orchestration platform 106 to a third different environment 110 (e.g., production environment 110C) of orchestration platform 106.

In response to second progression 424, device 400 can perform a binding procedure 428 in connection with second source of truth 124B. In that regard, a binary image (e.g., binary image 106C) that is to be deployed to production environment 110C can be bound to one or more second files 416B of the second source of truth 124B. As with binding procedure 414, binding procedure 428 can relate to marking or tagging a data structure or metadata structure of binary image 106 or with a reference to first file(s) 416B. Second file(s) 416B can be substantially similar in nature to first file(s) 416A, namely, second file(s) 416B can comprise API specification file 418, policy file 420, or the like.

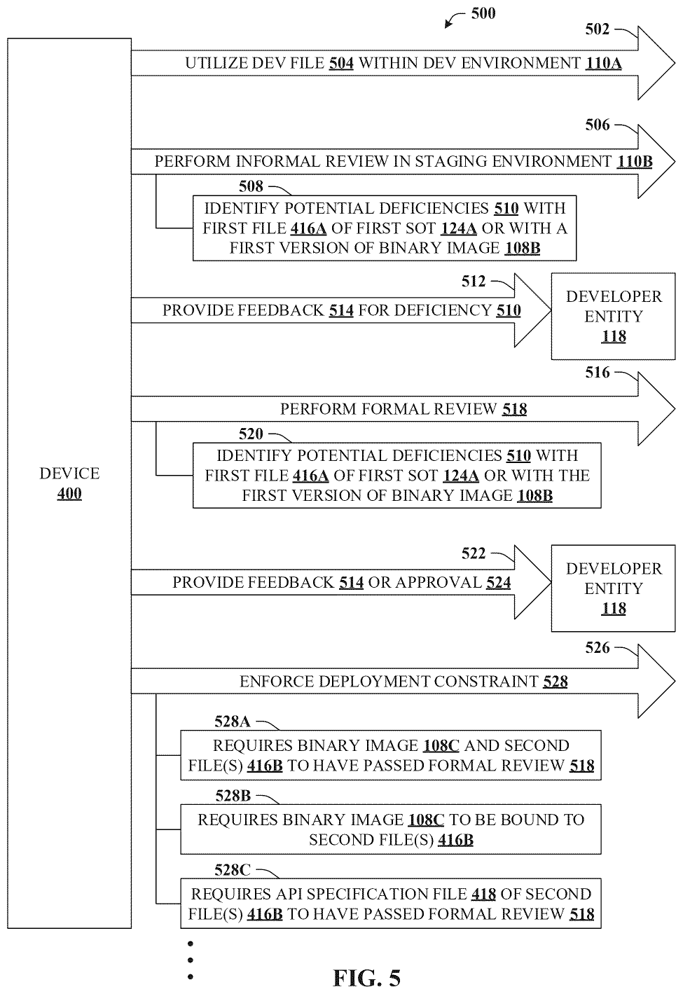

Turning now as well to FIG. 5, a schematic block diagram 500 is depicted illustrating additional aspects or elements of the example device 400 that can rely on multiple authoritative sources of truth 124 as a function of an operative environment 110 of an orchestration platform 106 in accordance with certain embodiments of this disclosure.

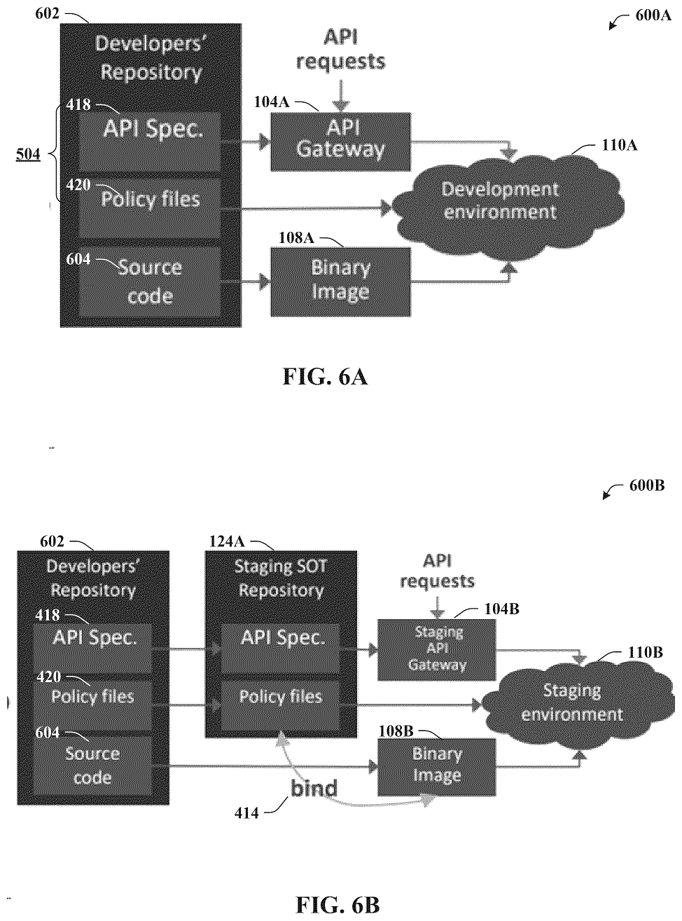

At reference numeral 502, device 400 can utilize dev file(s) 504 within dev environment 110A. In some embodiments, dev file(s) 504 can be similar in nature to files 416 such as first files 416A and second files 416B. In that regard, dev file(s) 504 can comprise some version of API specification file 418 and/or policy file 420. Additional detail regarding dev file 504 and other elements of the disclosed techniques can be found in connection with FIGS. 6A and 6B, which can now be referenced.

While still referring to FIG. 5, but turning now as well to FIGS. 6A and 6B, various schematic diagrams are depicted for different environments 110 of orchestration platform 106. With specific reference to FIG. 6A, a schematic block diagram 600A is depicted illustrating certain process flow aspects of API and policy governance 202 with respect to dev environment 110A of orchestration platform 106 in accordance with certain embodiments of this disclosure.

As shown, dev file 504 can be provided from repository 602 that is specific to developer entity 118. In other words, API specification file 418 can be provided to API gateway 104A (e.g., associated with dev environment 110A) from the developer's own repository 602. Likewise, policy files 420 can and binary image 108A (e.g., built by CI/CD pipeline 112 from source code 604) can be used in dev environment 110A. Hence, no specific constraints relating to API and policy governance 202 (e.g., formal review process 206) need be set in the dev environment 110A and software development project 120 can progress based on the pace of developer entity 118. Moreover, dev file(s) 504 can be owned by developer entity 118 from a security perspective.

With specific reference to FIG. 6B, a schematic block diagram 600B is depicted illustrating certain process flow aspects of API and policy governance 202 with respect to staging environment 110B of orchestration platform 106 in accordance with certain embodiments of this disclosure.

As illustrated developer entity 118 can publish a version of API specification file 418 and policy file 420 to the first (e.g., staging) source truth 124A repository. CI/CD pipeline 112 can then bind (e.g., binding process 414) binary image 108B to corresponding versions of API specification file(s) 418 and policy file(s) 420. Furthermore, CI/CD pipeline 112 can deploy the associated version of API specification file 418 to API gateway 104B (e.g., API gateway 104 specific to staging environment 110B) and the associated version of policy file 420 and binary image 108B to staging environment 110B.

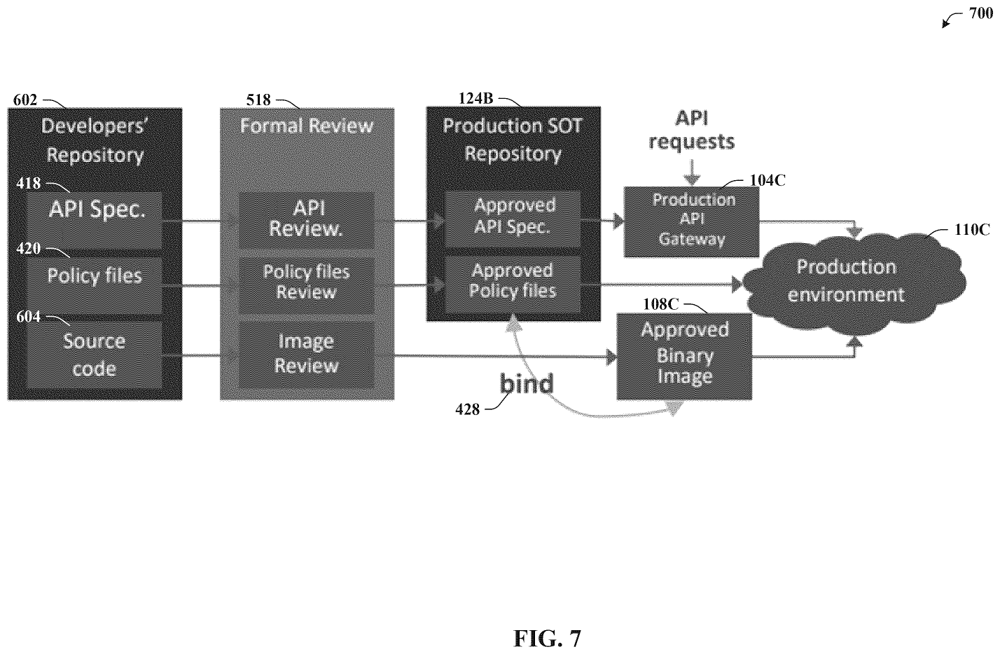

Before returning to FIG. 5, FIG. 7 can now be referenced. FIG. 7 depicts a schematic block diagram 700 illustrating certain process flow aspects of API and policy governance 202 with respect to a production environment 110C of orchestration platform 106 in accordance with certain embodiments of this disclosure.

At some point in the process of software development project 120 that is prior to going live in production environment 110C, developer entity 118 can submit a formal review request (e.g., see formal review 518 of FIG. 5 further detailed below and/or formal review process 206 detailed previously in connection with FIG. 2) for some version of API specification file(s) 418 and policy file(s) 420 (e.g., first files 416A).

In response, CI/CD pipeline 112 can merge the version of review approved (e.g., second files 416B) versions of API specification file(s) 418 and policy file(s) 420 to second source of truth 124B repository (e.g., source of truth 124 for production environment 110C). CI/CD pipeline 112 can bind (e.g., via bind procedure 428) binary image 108C to corresponding review-approved versions of second files 416B in source of truth 124B repository. Further, CI/CD pipeline 112 can publish the approved version of API specification file 418 to the API gateway 104C (e.g., the API gateway 104 of production environment 110C that is accessible by public traffic). CI/CD pipeline 112 can further deploy binary image 108C and the corresponding review-approved policy files 420 from the second source of truth 124B that can be owned and/or managed by orchestration platform 106.

Turning back to FIG. 5, at reference numeral 506, device 400 can perform an informal review. This informal review can be performed in response to a request from developer entity 118 while software development project 120 is in staging environment 110B or an earlier environment 110. As indicated at reference numeral 508, the informal review can identify potential deficiencies 510 with first files 416A (e.g., the current versions of API specification file 418 and policy file 420) of first source of truth 124A and/or with a current version of binary image 108 (e.g., binary image 108B).

In response to the informal review, as indicated at reference numeral 512, device 200 can generate and/or provide feedback 514 to developer entity 118. Feedback 514 can relate to the potential deficiency 510 and can be used by developer entity 118 to modify or correct first files 416A at some time prior to formal review. However, it is not strictly necessary to enforce such modification or correction prior to deployment to production environment 110C, allowing developer entity to progress as desired with respect to potential deficiencies 510.

At reference numeral 516, device 400 can perform a formal review 518. As with the informal review, formal review 518 can identify potential deficiencies 510 with first file(s) 416A associated with first source of truth 124A (e.g., files owned/managed by developer entity 118). In response to formal review 518, as illustrated at reference numeral 522, device 400 can generate and/or provide feedback 514 in the event potential deficiencies 510 exist. Otherwise (e.g., no potential deficiencies 510 are identified), device 400 can generate and/or provide an indication of approval 524 to developer entity 118. Hence, second files 416B can be representative of a certified and/or review-approved version of first files 416B. Likewise, binary image 108C can be representative of a certified and/or review-approved version of binary image 108B.

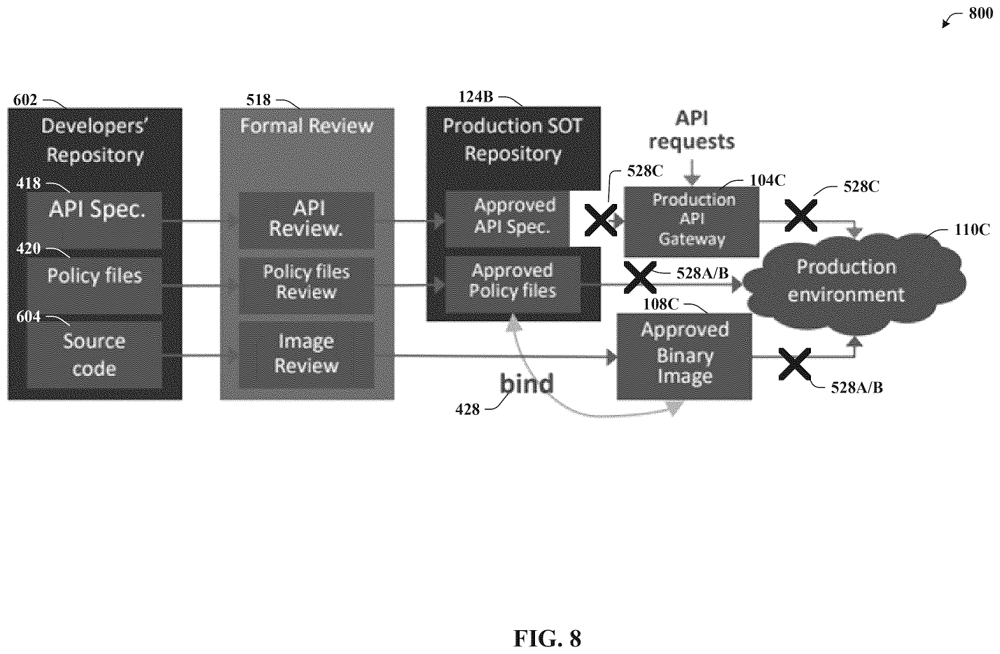

At reference numeral 526, device 400 can enforce one or more deployment constraints 528. Additional detail regarding deployment constraint 528 can be found in connection with FIG. 8. Hence, while still referring to FIG. 5, but also referring to FIG. 8, a schematic block diagram 800 is depicted illustrating various deployment constraints 528 being enforced in connection with a production environment 110C of orchestration platform 106 in accordance with certain embodiments of this disclosure. Hence, deployment constraint 528 can effectively tie formal review 518 to any suitable deployment process associated with software development project 120, particularly in connection with production environment 110C as illustrated here.

For example, enforcement of deployment constraint 528A can cause device 400 to prevent any version of binary image 108 (e.g., binary image 108C) and/or any version of second files 416B (e.g., policy file 420) from being deployed to the production environment 110C of orchestration platform 106 unless the binary image 108 and the associated second files 416B have successfully passed formal review 518.

As another example, enforcement of deployment constraint 528B can cause device 400 to prevent any version of binary image 108 (e.g., binary image 108C) and/or any version of second files 416B (e.g., policy file 420) from being deployed to the production environment 110C of orchestration platform 106 unless the binary image 108 has been bound (e.g., via binding procedure 428) to the associated second files 416B.

As still another example, enforcement of deployment constraint 528C can cause device 400 to prevent any version of any version of API specification file 418 (e.g., a member of the second file 416B) from being deployed to API gateway 104C or an associated production environment 110C of orchestration platform 106 unless the API specification file 418 has successfully passed a formal review 518 procedure.

### Example Methods

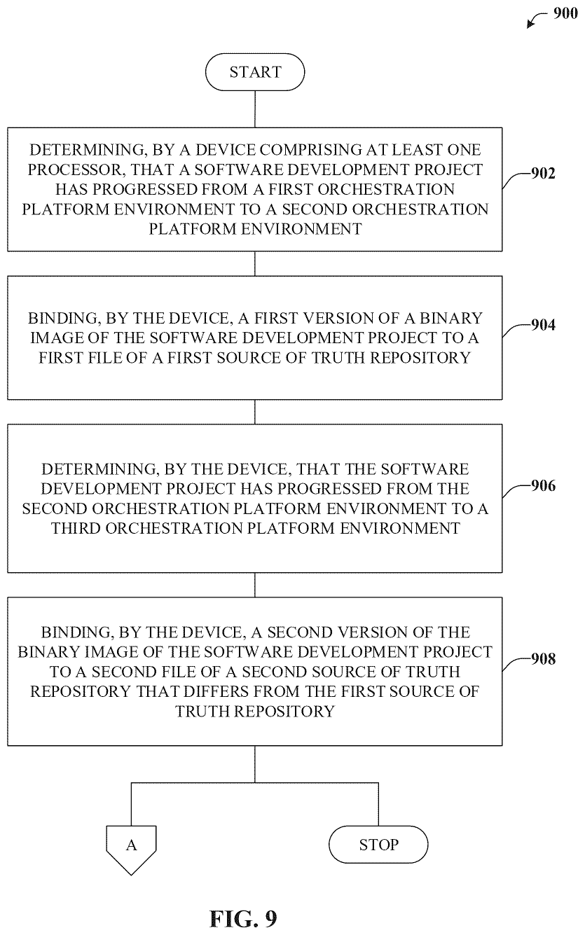

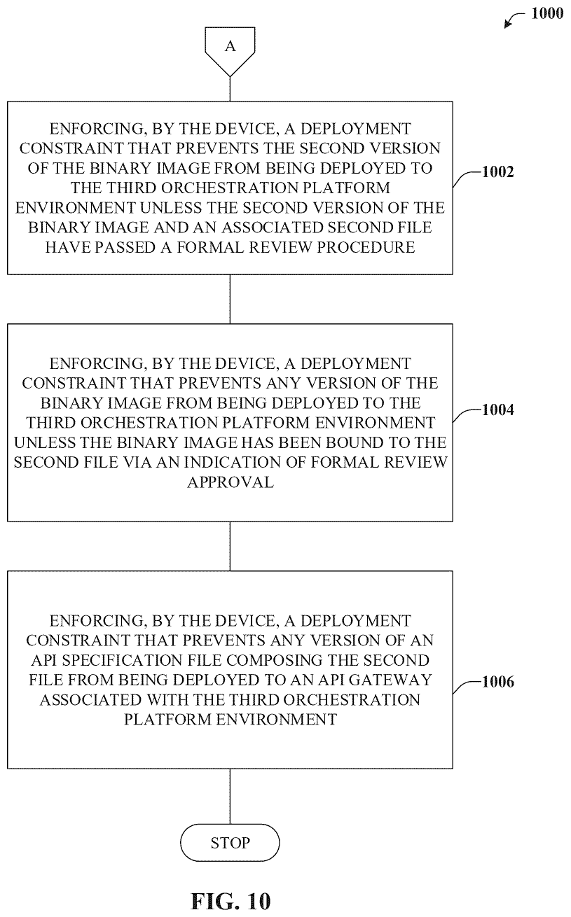

FIGS. 9 and 10 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Turning now to FIG. 9, exemplary method 900 is depicted. Method 900 can select from among multiple authoritative sources of truth based on an operative environment of an orchestration platform in accordance with certain embodiments of this disclosure. While method 900 describes a complete method, in some embodiments, method 900 can include one or more elements of method 1000, reached via insert A, as discussed at FIG. 10.

At reference numeral 902, a device comprising at least one processor can determine that a software development project has progressed from a first orchestration platform environment to a second orchestration platform environment. By way of example, the first orchestration platform environment can be a development environment and the second orchestration platform environment can be a staging environment.

At reference numeral 904, the device can bind a first version of a binary image of the software development project to a first file of a first source of truth repository. The first version of the binary image can be one that is deployed to the staging environment (e.g., the second orchestration platform environment) and the first source of truth repository can be one that is specifically allocated to the staging environment.

At reference numeral 906, the device can determine that the software development project has progressed from the second orchestration platform environment to a third orchestration platform environment. For example, the third orchestration platform environment can be a production environment of the orchestration platform.

At reference numeral 908, the device can bind a second version of the binary image (e.g., a finalized version of the software development project that is ready for the production environment. Said binding can bind the second version of the binary image of the software development project to a second file of a second source of truth repository that differs from the first source of truth repository. The second source of truth repository can be one that is specifically allocated for use in connection with the production environment. Method 900 can terminate in some embodiments, or proceed to insert A in other embodiments, which is further detailed in connection with FIG. 10.

Turning now to FIG. 10, exemplary method 1000 is depicted. Method 1000 can provide for additional functionality or elements relating to selecting from among multiple authoritative sources of truth based on an operative environment of an orchestration platform in accordance with certain embodiments of this disclosure. More particularly, Method 1000 can relate to enforcing one or more deployment constraints in a manner that effectively ties deployment of the software development project to formal review.

For example, at reference numeral 1002, the device introduced in FIG. 9 can further enforce a first deployment constraint that operates to prevent the second version of the binary image from being deployed to the third orchestration platform environment unless the second version of the binary image and an associated second file have passed a formal review procedure.

A reference numeral 1004, the device can enforce a second deployment constraint that operates to prevent any version of the binary image from being deployed to the third orchestration platform environment unless the binary image has been bound to the second file. Binding the binary image to the second file can be determined via an indication of formal review approval in a data or metadata structure of the binary image.

At reference numeral 1006, the device can enforce a third deployment constraint that prevents any version of an API specification file composing the second file from being deployed to an API gateway associated with the third orchestration platform environment.

### Example Operating Environments

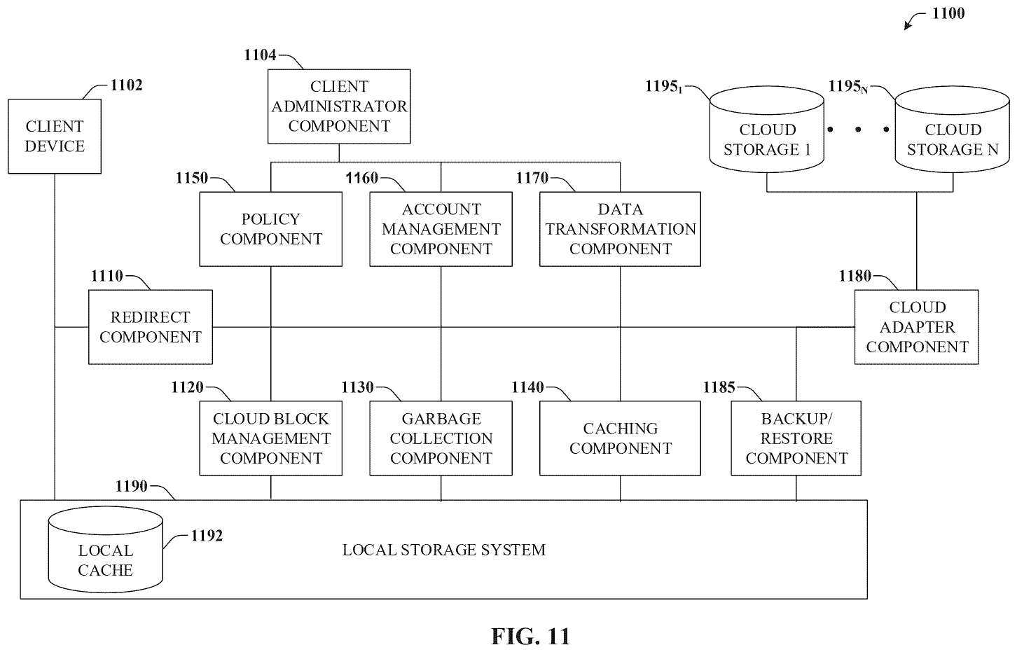

To provide further context for various example embodiments of the subject specification, FIGS. 11 and 12 illustrate, respectively, a block diagram of an example distributed file storage system 1100 that employs tiered cloud storage and block diagram of a computer 1202 operable to execute the disclosed storage architecture in accordance with example embodiments described herein.

Referring now to FIG. 11, there is illustrated an example local storage system including cloud tiering components and a cloud storage location in accordance with implementations of this disclosure. Client device 1102 can access local storage system 1190. Local storage system 1190 can be a node and cluster storage system such as an EMC Isilon Cluster that operates under OneFS operating system. Local storage system 1190 can also store the local cache 1192 for access by other components. It can be appreciated that the systems and methods described herein can run in tandem with other local storage systems as well.

As more fully described below with respect to redirect component 1110, redirect component 1110 can intercept operations directed to stub files. Cloud block management component 1120, garbage collection component 1130, and caching component 1140 may also be in communication with local storage system 1190 directly as depicted in FIG. 11 or through redirect component 1110. A client administrator component 1104 may use an interface to access the policy component 1150 and the account management component 1160 for operations as more fully described below with respect to these components. Data transformation component 1170 can operate to provide encryption and compression to files tiered to cloud storage. Cloud adapter component 1180 can be in communication with cloud storage 1 1195₁ and cloud storage N 1195_{N}, where N is a positive integer. It can be appreciated that multiple cloud storage locations can be used for storage including multiple accounts within a single cloud storage location as more fully described in implementations of this disclosure. Further, a backup/restore component 1185 can be utilized to back up the files stored within the local storage system 1190.

Cloud block management component 1120 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 1120 in chunks of data. A uniform chunk size can be selected where all files that are tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 1160 manages the information for cloud storage accounts. Account information can be populated manually via a user interface provided to a user or administrator of the system. Each account can be associated with account details such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 1120 based on a list of mappings that the cloud block management component 1120 manages. For example, each stub can be associated with an account, and the cloud block management component 1120 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 1180 manages the sending and receiving of data to and from the cloud service providers. The cloud adapter component 1180 can utilize a set of APIs. For example, each cloud service provider may have provider specific API to interact with the provider.

A policy component 1150 enables a set of policies that aid a user of the system to identify files eligible for being tiered to cloud storage. A policy can use criteria such as file name, file path, file size, file attributes including user generated file attributes, last modified time, last access time, last status change, and file ownership. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 1130. In another example, caching policies such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 1130 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 1140 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 1120, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 1140 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 1140 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that the file has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time the stub file is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 1170 can encrypt and/or compress data that is tiered to cloud storage. In relation to encryption, it can be appreciated that when data is stored in off-premises cloud storage and/or public cloud storage, users can request or require data encryption to ensure data is not disclosed to an illegitimate third party. In one implementation, data can be encrypted locally before storing/writing the data to cloud storage.

In one implementation, the backup/restore component 1185 can transfer a copy of the files within the local storage system 1190 to another cluster (e.g., target cluster). Further, the backup/restore component 1185 can manage synchronization between the local storage system 1190 and the other cluster, such that, the other cluster is timely updated with new and/or modified content within the local storage system 1190.

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various example embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an example embodiment, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more example embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device, comprising:
at least one processor; and
at least one memory that stores executable instructions that, when executed by the at least one processor, facilitate performance of operations, comprising:
in response to determining that a software development project has progressed from a first orchestration platform environment to a second orchestration platform environment, binding a first version of a binary image of the software development project to a first file of a first source of truth repository; and
in response to determining that the software development project has progressed from the second orchestration platform environment to a third orchestration platform environment, binding a second version of the binary image of the software development project to a second file of a second source of truth repository that differs from the first source of truth repository.

2. The device of claim 1, wherein the first orchestration platform environment is a development environment, the second orchestration platform environment is a staging environment, and the third orchestration platform environment is a production environment.

3. The device of claim 1, wherein the first file comprises at least one of a first application programming interface (API) specification file or a first policy file that is bound to the first version of the binary image within the second orchestration platform environment, and wherein the second file comprises at least one of a second API specification file or a second policy file that is bound to the second version of the binary image within the third orchestration platform environment.

4. The device of claim 3, wherein the first API specification file and the second API specification file define a structure, an endpoint, a parameter, or a response associated with an API of the software development project, and wherein the first policy file and the second policy file comprise a configuration setting or rule that defines how the API is accessed, secured, or managed.

5. The device of claim 1, wherein the operations further comprise utilizing a dev file that is received from a developer repository of a developer entity for the software development project within the first orchestration platform environment, and wherein the dev file comprises at least one of a dev API specification file or a dev policy file.

6. The device of claim 1, wherein the operations further comprise performing an informal review procedure configured to identify potential deficiencies with the first file associated with the first source of truth or the first version of the binary image.

7. The device of claim 6, wherein the operations further comprise, in response to the informal review procedure, generating feedback relating to the potential deficiency for a developer entity for the software development project.

8. The device of claim 1, wherein the operations further comprise performing a formal review procedure configured to identify potential deficiencies with the first file associated with the first source of truth or the first version of the binary image, or, in response to no potential deficiencies being identified, certifying the second file and the second version of the binary image as approved.

9. The device of claim 8, wherein the operations further comprise, in response to the formal review procedure, generating feedback relating to the potential deficiency for a developer entity for the software development project or, in response to no potential deficiencies being identified, generating an indication of approval.

10. The device of claim 1, wherein the operations further comprise enforcing a deployment constraint that prevents the second version of the binary image from being deployed to the third orchestration platform environment unless the second version of the binary image and an associated second file have successfully passed a formal review procedure.

11. The device of claim 1, wherein the operations further comprise enforcing a deployment constraint that prevents any version of the binary image from being deployed to the third orchestration platform environment unless the binary image has been bound to the second file via an indication of formal review approval.

12. The device of claim 1, wherein the operations further comprise enforcing a deployment constraint that prevents any version of an application programming interface (API) specification file composing the second file from being deployed to an API gateway associated with the third orchestration platform environment unless an associated API specification file has successfully passed a formal review procedure.

13. A non-transitory computer-readable medium comprising instructions that, in response to execution, cause a system comprising at least one processor to perform operations, comprising:
determining that a software development project has progressed from a first orchestration platform environment to a second orchestration platform environment;
binding a first version of a binary image of the software development project to a first file of a first source of truth repository;
determining that the software development project has progressed from the second orchestration platform environment to a third orchestration platform environment; and
binding a second version of the binary image of the software development project to a second file of a second source of truth repository that differs from the first source of truth repository.

14. The non-transitory computer-readable medium of claim 13, wherein the first orchestration platform environment is a development environment, the second orchestration platform environment is a staging environment, and the third orchestration platform environment is a production environment.

15. The non-transitory computer-readable medium of claim 13, wherein the first file comprises at least one of a first application programming interface (API) specification file or a first policy file that is bound to the first version of the binary image within the second orchestration platform environment, and wherein the second file comprises at least one of a second API specification file or a second policy file that is bound to the second version of the binary image within the third orchestration platform environment, and wherein the first API specification file and the second API specification file define a structure, an endpoint, a parameter, or a response associated with an API of the software development project, and wherein the first policy file and the second policy file comprise a configuration setting or rule that defines how the API is accessed, secured, or managed.

16. The non-transitory computer-readable medium of claim 13, wherein the operations further comprise implementing a deployment constraint that:
prevents the second version of the binary image from being deployed to the third orchestration platform environment unless the second version of the binary image and an associated second file has passed a formal review procedure;
prevents any version of the binary image from being deployed to the third orchestration platform environment unless the binary image has been bound to the second file via an indication of formal review approval, or
prevents any version of an API specification file, composing the second file, from being deployed to an API gateway associated with the third orchestration platform environment.

17. A method, comprising:
determining, by a device comprising at least one processor, that a software development project has progressed from a first orchestration platform environment to a second orchestration platform environment;
binding, by the device, a first version of a binary image of the software development project to a first file of a first source of truth repository;
determining, by the device, that the software development project has progressed from the second orchestration platform environment to a third orchestration platform environment; and
binding, by the device, a second version of the binary image of the software development project to a second file of a second source of truth repository that differs from the first source of truth repository.

18. The method of claim 17, further comprising enforcing, by the device, a deployment constraint that prevents the second version of the binary image from being deployed to the third orchestration platform environment unless the second version of the binary image and an associated second file have passed a formal review procedure.

19. The method of claim 17, further comprising, enforcing, by the device, a deployment constraint that prevents any version of the binary image from being deployed to the third orchestration platform environment unless the binary image has been bound to the second file via an indication of formal review approval.

20. The method of claim 17, further comprising, enforcing, by the device, a deployment constraint that prevents any version of an application programming interface (API) specification file composing the second file from being deployed to an API gateway associated with the third orchestration platform environment.
